(19) United States
(12) Patent Application Publication
(10) Pub. No.: US 2022/0130165 A1
(43) Pub. Date: Apr. 28, 2022

(54) DRIVING AND IMAGE ACQUISITION METHOD APPLIED TO UNDER-SCREEN IMAGING, STORAGE MEDIUM, AND ELECTRONIC DEVICE

(71) Applicant: SHANGHAI HARVEST INTELLIGENCE TECHNOLOGY CO., LTD., Shanghai (CN)

(72) Inventor: Zongwen CHEN, Shanghai (CN)

(73) Assignee: SHANGHAI HARVEST INTELLIGENCE TECHNOLOGY CO., LTD., Shanghai (CN)

(21) Appl. No.: 17/275,387

(22) PCT Filed: Aug. 7, 2019
(86) PCT No.: PCT/CN2019/099637

§ 371 Date: Jan. 14, 2022

(30) Foreign Application Priority Data
Sep. 12, 2018 (CN) 201811061474.1
Sep. 12, 2018 (CN) 201811062040.3

(51) Int. Cl. G06V 40/13; G02F 1/1333

(52) U.S. Cl. CPC G06V 40/1318; G02F 1/13338

(57) ABSTRACT

This invention publishes a driving and image obtaining method for under-screen imaging, a storage medium and an electronic device, wherein the driving method includes: lighting up pixels of a plurality of separate point light source areas of a display panel, the point light source areas being arranged in arrays and spaced with nonluminous pixel points; and obtaining, through a photoelectric sensor, light emitted by the pixel points that is totally reflected by a light-permeable cover plate; the display panel and the photoelectric sensor being placed under the light-permeable cover plate. Compared with the existing techniques, the driving method of the present invention improves imaging efficiency by lighting up pixels of multiple point light source areas simultaneously, obtaining a large amount of image information each time; since multiple pixels form a point light source, a brightness of the point light source is increased, and the quality of optical image imaging under the lens-less screen is improved.

### TECHNICAL FIELD

The present invention is related to the technical field of under-screen imaging, and especially related to a driving and image obtaining method for under-screen imaging, a storage medium and an electronic device.

### BACKGROUND ART

As information technology develops, biometric identification technology plays a more and more important role in an aspect of ensuring information security, wherein fingerprint recognition has become one of the key technical measures for identity identification and device-unlocking that are widely applied in the field of mobile networking. Under the trend that the screen-to-body ratios of electronic appliances get larger and larger, conventional capacitive fingerprint recognition has failed to meet the requirements, and ultrasonic fingerprint recognition has problems in aspects of technical maturity, cost, etc. Optical fingerprint recognition is expected to become a major technical scheme of under-screen image recognition.

An existing scheme for optical fingerprint recognition is based on principles of geometric optical lens imaging, and a fingerprint module used therein includes components such as a micro-lens array and an optical spatial filter, and has many drawbacks such as having complicated structure, thick module, small sensing range, high cost, etc.

### CONTENT OF INVENTION

This invention provides a driving and image obtaining method for under-screen imaging, a storage medium and an electronic device, in order to solve the problem that ordinary uniform illumination light source cannot meet the needs for the principle of total reflection imaging.

The driving method includes: lighting up pixels of a plurality of separate point light source areas of a display panel, the point light source areas being arranged in arrays and spaced with nonluminous pixel points; through photoelectric sensor, light of the pixel points that is totally reflected by light-permeable cover plate; the display panel and the photoelectric sensor being placed under the light-permeable cover plate.

Optionally, the array arrangement is 1 lateral-arrangement-and-longitudinal-arrangement, or the array arrangement is ring arrangement.

Optionally, an interval between two adjacent point light sources satisfies a condition that point light source total reflection images that are collected by the photoelectric sensor do not contact and do not repeat.

Optionally, a wavelength of the point light sources is 515 nm to 700 nm.

Optionally, prior to lighting up the pixels, the driving method further includes: performing value-assignment for a matrix that has a same resolution as that of the display panel, assigning non-zero values to the point light source areas, assigning a zero value to other regions, and generating a display image using the matrix that has assigned values as RGB information; transmitting the display image to the display panel.

Optionally, the point light source areas include a plurality of pixel points.

Optionally, the point light source area is a circle-like shape, a rectangle, a rhombus, or a triangle.

Optionally, the display panel is a liquid-crystal display, an active-matrix organic light-emitting diode display or a micro light-emitting diode display.

Optionally, the driving method further includes steps of: after a preset time interval, performing a same position offset on all of the point light source areas; repeating the step of lighting up pixels and the step of obtaining light.

Optionally, the repeating of the step of lighting up pixels and the step of obtaining light includes: repeating the step of lighting up pixels and the step of obtaining light for a preset number of times.

Optionally, the preset number of times is six or more.

Optionally, the position shifting includes shifting the point light source in a direction toward an adjacent point light source; an interval of the position shifting is the interval between the adjacent point light sources divided by an integer.

Optionally, the array arrangement is lateral arrangement and longitudinal arrangement that are perpendicular to each other; the position shifting includes a lateral shifting, a longitudinal shifting, or a shifting in a direction of ±45 degrees.

Optionally, an interval of the lateral shifting is a lateral interval between the adjacent point light sources divided by an integer; an interval of the longitudinal shifting is a longitudinal interval between the adjacent point light sources divided by an integer; an interval of the shifting in the direction of ±45 degrees is an interval between the adjacent point light sources in the direction divided by an integer.

An embodiment of the present invention further provides an image acquisition method used for imaging under screen, including: acquiring light data using a driving method of the embodiments of the present invention; and performing stitching process on the light data obtained by the photoelectric sensor in multiple instances of the step of lighting up pixel points and multiple instances of the step of obtaining light, so as to obtain stitched image data.

An embodiment of the present invention further provides a storage medium, the storage medium stores a computer program, when the computer program is executed by a processor, steps of the driving method of the embodiments of the present invention are implemented.

An embodiment of the present invention further provides an electronic device, including storage, a processor and an image obtaining structure. The image obtaining structure includes a light-permeable cover plate, a display panel and a photoelectric sensor. The display panel and the photoelectric sensor are placed under the light-permeable cover plate. The processor is coupled to the display panel and the photoelectric sensor. The storage stories a computer program therein, and the computer program, when executed by the processor, performs the steps of the driving method of the embodiments of the present invention.

Compared with the prior art, the technical scheme of the embodiments of the present invention has the following beneficial effects:

The driving method used for under-screen imaging of the embodiment of the present invention obtains a large amount of image information each time by lighting up pixel points of multiple point light source areas simultaneously, enhancing imaging efficiency; since multiple pixel points form a point light source, the brightness of the point light source is increased, and the quality of lens-free under-screen optical imaging is improved.

Further, the driving method adopts a time division multiplexing technique, that is, performing the same position shifting on all the point light source areas multiple times, light data covering all under-screen images may be obtained, thereby improving imaging efficiency.

The image acquiring method used for under-screen imaging of the embodiment of the present invention includes acquiring light data by using the driving method of the embodiment of the present invention; and performing stitching process on the light data obtained by the photoelectric sensor in multiple times of the step of lighting up pixel points and multiple times of the step of obtaining light, so as to obtain stitched image data, thereby obtaining complete image data and improving the efficiency of image acquisition.

### DESCRIPTION OF ACCOMPANYING FIGURES

FIG. 1 is a schematic diagram of lens-free under-screen optical fingerprint imaging implemented by using the principle of total reflection imaging;

FIG. 2 is a flowchart of a driving method used for under-screen imaging of an embodiment of the present invention;

FIG. 3 is a schematic diagram of an array of a plurality of separate point light source areas of a display panel of an embodiment of the present invention;

FIG. 4 is a distribution diagram of pixel points included in a point light source of an embodiment of the present invention;

FIG. 5 is a flowchart of a driving method of another embodiment of the present invention;

FIG. 6 is a flowchart of an image acquiring method used for under-screen imaging of an embodiment of the present invention;

FIG. 7 is a schematic diagram of intervals among point light sources and fingerprint acquisition of an embodiment of the present invention;

FIG. 8 is a schematic diagram of shifting of point light sources in different image collections of the present invention;

FIG. 9 is fingerprint image data obtained by an embodiment of the present invention.

Description of symbols of the accompanying figures:
O: illuminating point, O′: another illuminating point, A: contact point between a fingerprint and a light-permeable cover plate,
O″: projection point of the illuminating point O on a photoelectric sensor;
A′: corresponding position of the illuminating point O on the display panel;
B, B′: imaging point;
1, 1′, 1″: point light source;
2: fingerprint image.

### SPECIFIC IMPLEMENTATION MANNER

In order to describe the technical content, structural features, achieved goals and effects of the technical scheme(s) in detail, the following provides detailed description in combination with specific embodiments and the accompanying figures.

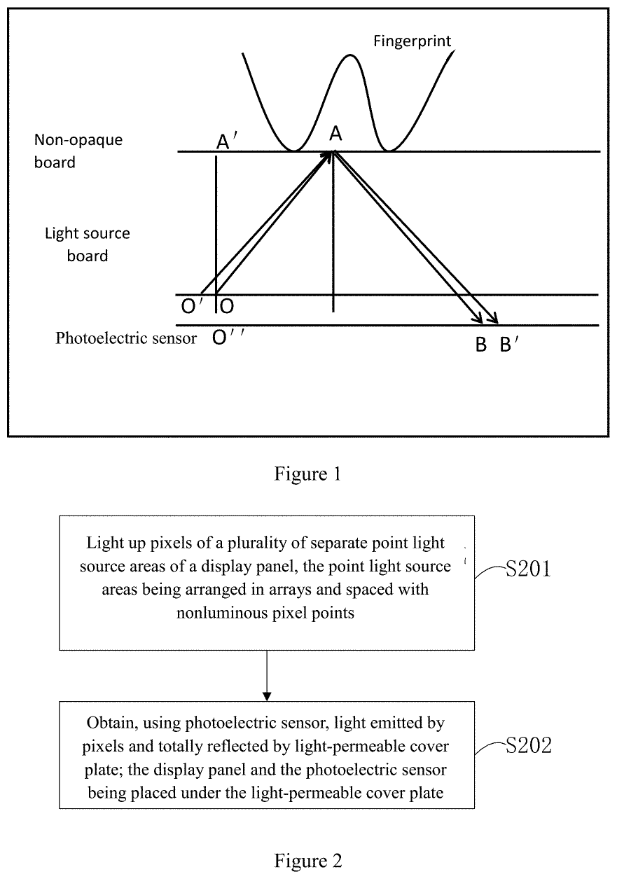

Please refer to FIG. 1 to FIG. 5. This embodiment provides a driving method used for under-screen imaging. This method is applied to an under-screen-image imaging structure. As shown in FIG. 1, the under-screen imaging structure includes a light-permeable cover plate, a display panel and a photoelectric sensor, and the display panel and the photoelectric sensor are placed below the light-permeable board. The light-permeable cover plate may be a single-layer board structure or a multilayer structure. The single-layer structure may be a glass cover plate or a cover plate with an organic light-permeable material. The single-layer cover plate may also be a cover plate with other functions, such as a touch screen. The multilayer structure may be multiple layers of glass cover plates, or multiple layers of cover plates of organic light-permeable material, or a combination of glass cover plate(s) and cover plate(s) of organic light-permeable material. The photoelectric sensor is used to obtain light and perform photoelectric conversion. The photoelectric sensor includes a plurality of photosensitive units, and the plurality of photosensitive units may be individually disposed below the display panel or disposed on the display panel. When the plurality of photosensitive units are disposed below the display panel, light can pass through gaps among the light sources on the display panel into the photoelectric sensor. When the plurality of photosensitive units are disposed on the display panel, the photosensitive units may be disposed in gaps among the light sources (pixel points) of the display panel. The sensor can be disposed in the under-screen-image imaging structure for acquiring under-screen images, such as a fingerprint, a palm print, etc. The light-permeable cover plate and the display panel need to be connected by filling optical cement, in order to prevent air from interfering with reflection of light, and a refractive index of the optical cement should be as close to a refractive index of the light-permeable cover plate as possible to prevent total reflection of light from occurring between the optical cement and the light-permeable cover plate.

A principle of total-reflection imaging is that, when imaging, a finger contacts the light-permeable cover plate, and due to air being present in the fingerprint depressions, light with an incident angle exceeding the critical angle of total reflection will form total reflection, so the photoelectric sensor will collect bright light, while convex parts of the fingerprint are in contact with an upper surface of the light-permeable cover plate, the light will not have total reflection, and the photoelectric sensor will collect darker light, and thus a fingerprint image can be discerned. When implementing obtaining of a fingerprint, a certain point A on the glass cover plate (cover glass) that is pressed by a finger is to be imaged onto a point B on a surface of the sensor. Based on conditions of the total reflection, the light emitted by a single illuminating point O on the light source plate is just sufficient to satisfy the needs. If another illuminating point O′ is present near the point O, the point A on the glass cover plate will have two image points B and B′ on the surface of the sensor, resulting in a blurred image. From the aspect of clarity of optical imaging, the occurrence of two image points needs to be avoided as much as possible, so an ideal light source satisfying the purpose of under-screen imaging should be a point light source.

However, in practical application, many restrictions must be considered, which include that (1) brightness of a single pixel point of an existing display panel usually does not meet imaging requirements, and that (2) space under the screen is very small, and a range illuminated by of a single point light source is also very small, and therefore for large-area image acquisition, an acquisition speed would be very slow.

This embodiment first combines a plurality of pixel points together to form a composite point light source with overall brightness that meets imaging requirements. By lighting the finger simultaneously using multiple separate and composite point light sources, the requirements of fast under-screen-image imaging can be met.

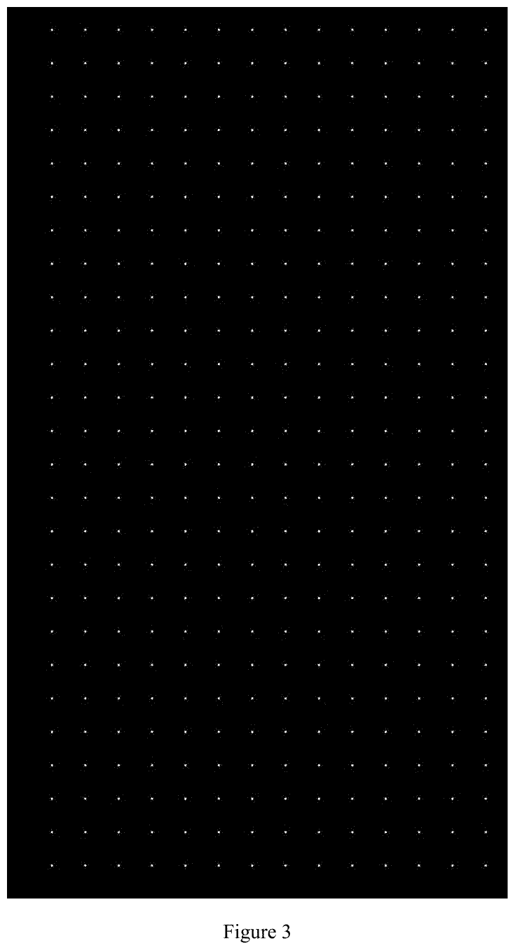

When implementing driving of the display panel, a driving method includes the following steps as shown in FIG. 2, step S201, step of lighting up pixel points: lighting up pixel points of a plurality of separate point light source areas of a display panel, wherein the point light source areas are arranged in an array and are spaced with nonluminous pixel points. The point light source areas include a plurality of pixel points, and preferably the plurality of pixel points have the same color. Step S202, step of obtaining light: obtaining, using the photoelectric sensor, light of the pixel points that is totally reflected by the light-permeable cover plate; wherein the display panel and the photoelectric sensor are placed under the light-permeable cover plate. In this embodiment, the plurality of separate point light source areas can illuminate multiple areas on the light-permeable cover plate, and then the light that has been totally reflected by the upper surface of the light-permeable cover plate can be obtained by the photoelectric sensor. In this manner, images of multiple areas may be obtained, improving image acquisition efficiency. At the same time, the point light source areas include multiple pixel points, which meets the brightness requirements for imaging and can realize collection of images on the light-permeable cover plate.

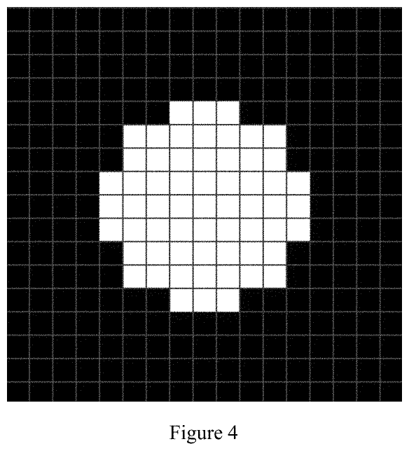

In this embodiment, the array arrangement of the point light sources has a variety of arrangements, and preferably is a uniform arrangement; that is, intervals between any two point light sources are equal, so that an image reflected by each of the point light sources is the same, which is convenient for subsequent image processing. The specific arrangement may be lateral-arrangement-and-longitudinal-arrangement, or the array arrangement is ring arrangement. The horizontal-arrangement-and-vertical-arrangement is one in which a plurality of point light sources constitute a plurality of parallel horizontal rows and a plurality of parallel vertical columns. As shown in FIG. 3, where the white points are point light sources, preferably the horizontal rows and the vertical columns are perpendicular to each other, and of course, a certain included angle (such as 60 degrees) may appear in some embodiments. The ring arrangement may be that the point light sources are located in circles with gradually increasing radii and with a center of the screen serving as their center.

The interval between the point light sources depends on imaging quality, and this interval is determined by an interval between the light source and the upper surface of the light-permeable cover plate, and these two intervals are directly proportional. In order to prevent overlap between images, the interval between two adjacent point light sources satisfies a condition that point light source total reflection images that are collected by the photoelectric sensor do not contact and do not repeat. Preferably, the interval between the point light sources may take a minimum value under the condition that total reflection images of two adjacent point light sources do not contact and do not repeat. This minimum value can be obtained manually through multiple trials by, for example, obtaining total reflection images of point light sources with different intervals of the point light sources, and then checking a minimum value of the intervals of the point light sources in reflected images satisfying the conditions of non-contact and non-repetition. Afterwards, this minimum value can then be set in advance in a storage device on which the method is executed. The interval of the point light sources in reality will be affected by the hardware parameters of imaging structures such as the display panel, the photoelectric sensors, and the light-permeable cover plate. In practical applications, the hardware parameters of a screen product generally remain unchanged, and for these specific screens, the manner of manually trying multiple times for the attainment is more direct and convenient. In some embodiments, the interval of the point light sources can also be relatively small, so that during one light acquisition, the total reflection images of a single point light source will overlap with one another, and the overlapped parts need to be removed during image processing, which increases workload per image processing.

Just as described above, the present invention combines multiple pixel points together to form a composite point light source with overall brightness that meets imaging requirements, which means that the brightness of a point light source must meet the requirements that it can be obtained by a photoelectric sensor. A number of pixel points has an inverse linear relationship with a brightness of the pixel points of the display panel. At the same time, an outer shape of the point light source also affects the imaging quality. The outer shape of the point light source may be a rectangle, a rhombus, or a triangle. Preferably, the point light source region is a circle-like shape. Since in practice, every pixel is actually a square, a combination of multiple pixels cannot form a standard circle, and can only form a circle-like shape that is close to a circle. Determination of pixel points of a circle-like shape can be made by drawing a circle with a certain pixel point serving as the center. The pixel points inside the circle can all be considered as the pixel points of the circle-like shape. A predetermined ratio of occupied area can be set for pixel points on the circumference. When a ratio of the area inside the circle that is occupied by the circumference pixel points to the total area of the pixel points is larger than the predetermined ratio of occupied area, the pixel points are considered as pixel points of the point light source for the circle-like shape. The size of the circle determines light intensity of the point light source and whether the photoelectric sensor is able to obtain images with better quality. If the circle is too small, the point light source region would be too small, thereby producing insufficient light; if the circle is too big, the point light source region would be too big, thereby affecting imaging quality. Similarly, different display panels may have different light source intensities, so the size of the point light source region also varies from display panel to display panel. For a particular image-imaging-acquiring structure, the size of the point light source region can also be obtained by adopting multiple manual testings. The size of the point light source region can be lit up in a small-to-large order. Then, after the photoelectric sensor has obtained image data, a smallest point light source region with a satisfying imaging quality is manually selected.

With existing display panels, the number of pixel points can be a rectangle with an edge of a length of 2-15 pixel points. In some embodiments, preferable size and shape of a real point light source are shown in accompanying FIG. 4 (each grid represents a pixel, and positions of light sources are indicated by the white color), where a rectangle of 7pixel*7pixel is in the middle with a projection of three pixels in the middle of each side of the rectangle, which can achieve relatively better imaging quality.

A wavelength of the preferred light source is 515 nm to 700 nm, that is, green (515 nm-560 nm), red (610 nm-700 nm), or any color combination of a color between these two colors and another color. Such colors are most sensitive to the photoelectric sensor, which is beneficial to the light acquisition by the photoelectric sensor.

Display panels can be used not only as light sources to emit light, but can also function to display images. Display panels include liquid-crystal displays (LCDs), active-matrix organic light-emitting diode (AMOLED) displays or micro light-emitting diode (micro-LED) displays; they each scan and drive a single pixel by a thin-film transformer (TFT) structure, and can achieve single driving for a pixel point, thereby achieving driving of the point light source and array-displaying, and allowing light to enter the photoelectric sensor after passing through gaps among pixel points.

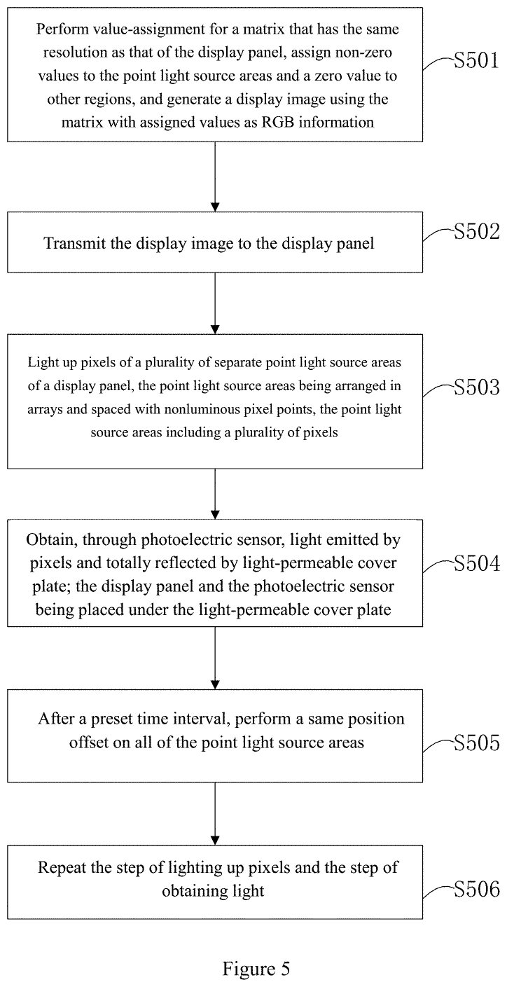

The point light source array structure of this embodiment may be drawn using various ways of generation, such as using a graphic software to implement drawing and then displaying by the display panel. However, since accuracy requirement of a dot matrix is high and the number of points is relatively large, this manner of drawing has a low efficiency. Alternatively, the method shown in FIG. 5 may be adopted: before lighting up pixel points in step S503, image acquisition method used for under-screen imaging further includes: in step S501, performing value-assignment for a matrix that has the same resolution as that of the display panel, wherein non-zero values are assigned to point light source regions, zero is assigned to the other regions, and the matrix that has the assigned values serves as RGB information for generating a display image; in step S502, transmitting the display image to the display panel. Afterward, steps S503 and S504 which are the same as steps S201 and S202 are performed. In this embodiment, an active-matrix organic light-emitting diode (AMOLED) display (1920×1080 pixels) is taken as an example to describe generation of the point light source array structure. A programming language is used with this parameter to design a light source topology structure. The procedure of using the programming language to design the light source topology structure is in fact to assign values to a 1920*1080 matrix (a matrix that has 1920 rows, 1080 columns and all-zero data) by assigning a non-zero value (e.g., 255) to positions that need to be lit up and assigning a value of 0 otherwise, and then to use this matrix as RGB information of an 8-bit image (in the RGB information of an 8-bit image, a datum of 0 represents a black color, and a datum of 255 represents a fully saturated color) to generate a new image. A point light source array structure thus generated is shown in accompanying FIG. 3, wherein the white color represents the point light source region. The color of white is used only for graphic illustration, and can actually be green or red. Through steps S501 and S502, a point light source array structure as needed may be generated with high efficiency, and thereby high-speed point light source driving may be achieved.

Continuing to refer to FIG. 1, if a point A on the glass cover plate (cover glass) pressed by a finger is to be imaged at a point B on a surface of a sensor, according to the total reflection condition, light emitted by a light point O on a light emitting layer just satisfies the requirement. Since space under the screen is very small, and a range illuminated by a single point light source is also very small, multiple separate point light sources must be used to light the finger simultaneously, so as to meet the requirements of fast under-screen imaging of the fingerprint. However, each point light source O forms an image (non-total reflection imaging) at the position O″ on the sensor directly below, and total reflection imaging of the fingerprint at point A′ directly above the point light source O cannot be fully realized because the incident angle of light is smaller than the critical angle, resulting in deficiency on the fingerprint images. Although multiple pixel points form a point light source for illuminating the fingerprint at the same time, a single imaging cannot implement seamless scanning on the full fingerprint. Traditional fingerprint scanning mainly adopts a same part correspondence stitching method to connect small pieces of fingerprint information. Such method is unable to solve the existing phenomenon that some areas of the image are enlarged. At the same time, if the existing scanning mode “progressive scanning” and “interlaced scanning” are used, only one row or one column of information can be collected at a time, and the collected information is very limited. None of these can meet the requirements for quickly collecting complete image based on the point light source array. If multiple point light source arrays that are too dense are used to complement each other, scanning of a full fingerprint can be achieved, but the fingerprint images obtained by illumination of each point light source array will overlap with one another, and subsequent processing is very difficult. In order to avoid overlapping, the interval of the point light sources of the present application satisfies the condition that the images do not overlap. However, some fingerprint images are lost by doing so. In order to obtain a complete fingerprint image, the present invention uses time-division multiplexing technology to achieve full coverage of the fingerprint image.

Specifically, as shown in FIG. 5, after a predetermined time interval in step S505, a same position shifting on all of the point light source areas is performed; in step S506, step S503 of lighting up pixel points and step S504 of obtaining light are repeated, until the fingerprint images that satisfy the full requirements for fingerprint stitching are obtained, and then de-noising and stitching are performed on the fingerprint images, by which the complete fingerprint image may be obtained.

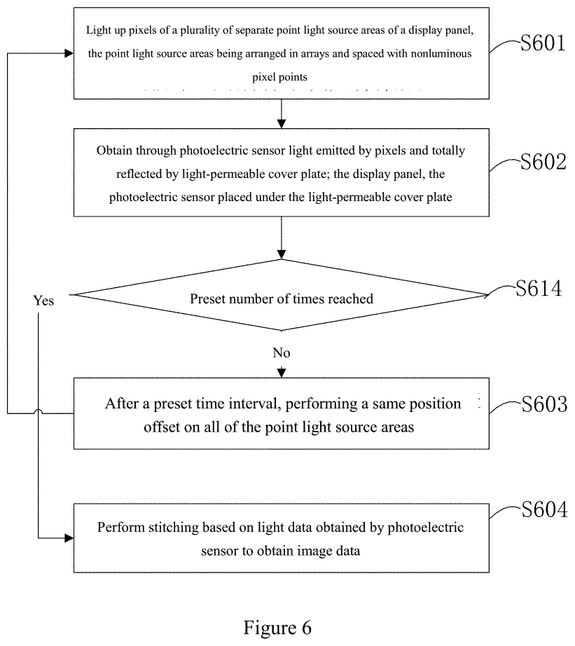

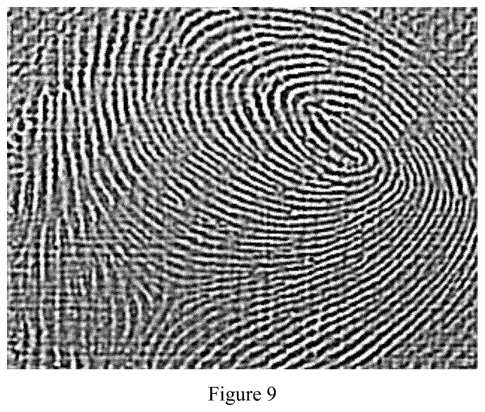

In order to achieve full image coverage, an embodiment of the present invention further provides an image acquisition method used for under-screen imaging. As shown in FIG. 6, the image acquisition method includes the following steps: step S601, lighting up pixel points of a plurality of separate point light source areas of a display panel, wherein the point light source areas are arranged in arrays and are spaced with nonluminous pixel points; step S602, obtaining, using a photoelectric sensor, light of the pixel points that is totally reflected by a light-permeable cover plate, wherein the display panel and the photoelectric sensor are placed under the light-permeable cover plate; step S603, after a preset time interval and after performing the same position shifting on all of the point light source areas, repeating the step of lighting up pixel points and the step of obtaining light; step S604, after repeating the above-mentioned steps for a predetermined number of times, performing stitching process based on the light data acquired by the photoelectric sensor, so as to obtain image data. By lighting up pixel points of multiple point light source areas simultaneously, a large amount of image information may be obtained each time, and by performing the position shifting multiple times, light data covering all under-screen images may be obtained, and finally the images corresponding to the light data are stitched so as to obtain complete image data, as shown in FIG. 9.

In practical application, in order to implement image stitching in step S604, pre-process must be performed on the image data of the light collected each time, scaling process is performed on the acquired image data, invalid image data is removed, an effective image area of the light data collected each time is obtained, and complete image data can be obtained by stitching the effective image areas. In stitching, generally the same parts of the image area are overlapped together to achieve the extension of different parts of the image area until the entire image is obtained. Also, for the step to be executed by the preset number of times, it is generally to determine whether the preset number of times has been reached after the end of step each time, and it is generally conducted before the position shifting, as shown in step S614 of FIG. 6 to avoid unnecessary position shifting.

The position shifting is done to obtain image information that is missing. To facilitate subsequent image stitching, the distance of each position shifting must be equal. Also, a preferred shifting direction is that the point light source is shifted in a direction toward the adjacent point light source; an interval of the position shifting is the interval between the adjacent point light sources divided by an integer. For example, one-third or one-eighth of the interval between the centers of the adjacent point light sources is shifted each time. In this way, the image data between the point light sources can be obtained at equal intervals, and the same algorithm can be used for image stitching, which is more efficient to process.

The array arrangement of the point light sources in this embodiment has a variety of arrangements, and preferably is an uniform arrangement; that is, the intervals between any two point light sources are equal, so that the images reflected by all point light sources are also equal, which is convenient for subsequent image processing. The specific manner of the arrangement may be lateral-arrangement-and-longitudinal-arrangement, or the array arrangement is ring arrangement. The horizontal arrangement is one in which a plurality of point light sources constitute a plurality of parallel horizontal rows and a plurality of parallel vertical columns. As shown in FIG. 3, where the gray points are point light sources, preferably the horizontal rows and the vertical columns are perpendicular to each other, and of course, a certain included angle (such as 60 degrees) may appear in some embodiments. The ring arrangement may be that the point light sources are located in circles with gradually increasing radii and with a center of the screen serving as their center. The gray in the image is for illustration only. The preferred wavelength of the light source is 515 nm to 700 nm, or the color is green (515 nm-560 nm), red (610 nm-700 nm) or any color combination of a color between these two colors and another color. Such colors are most sensitive to the photoelectric sensor, which is beneficial to the light acquisition of the photoelectric sensor.

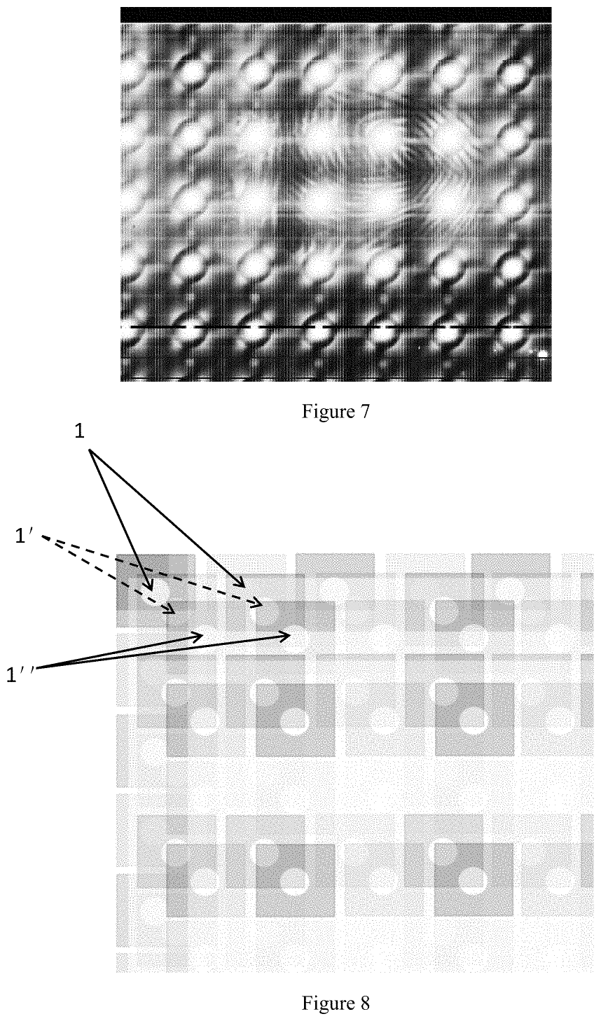

In a preferred embodiment, as shown in FIG. 3, the array arrangement includes horizontal arrangement and vertical arrangement that are perpendicular to each other, and the position shifting includes lateral shifting, longitudinal shifting, or shifting in a direction of ±45 degrees; an interval of the lateral shifting is a lateral interval between the adjacent point light sources divided by an integer; an interval of the longitudinal shifting is a longitudinal interval between the adjacent point light sources divided by an integer; an interval of the shifting in the direction of ±45 degrees is an interval between the adjacent point light sources in the direction divided by an integer. The shifting can be a single lateral shift, a longitudinal shift, or a shift in the direction of ±45 degrees, or can be a combination of these kinds of shifts. A total number of light acquisitions is the number of horizontal light acquisitions multiplied by the number of vertical light acquisitions. The more times the position is shifted, the more times the light is acquired, and the more image information is collected. However, the collection time increases. In order to save time, it is needed to reduce the number of position shifting as much as possible on the premise that the entire image can be stitched. This requires more image information to be collected each time the light is acquired, which is related to parameters such as the brightness parameters of the display panel, the thickness of the light-permeable cover plate, and the light sensitivity of the sensor. After scaling, a position of the fingerprint information collected by the point light source array at one time is shown in FIG. 7, where 1 is the point light source, and 2 is the acquired fingerprint image. It can be seen that the fingerprint collected in one image collection is not complete, and position information from multiple different locations is needed to combine into a complete fingerprint. The display panels and photoelectric sensors commercially available on the market generally need to collect more than 6 times, and can obtain a more complete under-screen image. Using collecting 24 pictures as an example, a scanning mode is designed to use the first picture as the initial position, and move it one eighth of the pitch toward the right and bottom (pitch refers to a distance between every two point light sources, and the distance is determined based on the system hardware parameters). After a total of seven shifts, the initial position is moved to the right by one third of the pitch, and it is further moved down to the right by one eighth of the pitch seven times, to obtain the second round of eight images, and then proceed to move to the right by one third of the pitch, and then repeat to the right and down to complete collection of the last eight images. As shown in FIG. 8, the point light source collected each time is shifted from the last collection, where 1 is a center of the point light source of the first image collection, 1′ is the center the point light source of the image collection after shifting, and 1″ is the center of the point light source of the image collection after another shifting. In this way, by using multiple combined scanning modes such as horizontal, vertical, and diagonal, lens-free imaging positions are adapted; after multiple scanning, the position of the center point of each small area is detected and enlarged, and then stitched into a complete image, as shown in FIG. 9.

In order to satisfy the brightness requirements of the light collection, the point light source areas include a plurality of pixel points, and preferably the plurality of pixels have the same color. By adding the brightness of multiple pixel points, the photoelectric sensor is capable of acquiring data of the light reflected by the point light source. At the same time, an outer shape of the point light source also affects the imaging quality. Preferably, the point light source region is a circle-like shape. Since in practice, every pixel is actually a square, a combination of multiple pixels cannot form a standard circle, and can only form a circle-like shape that is close to a circle. Determination of pixel points of a circle-like shape can be made by drawing a circle with a certain pixel point serving as the center. The pixel points inside the circle can all be considered as the pixel points of the circle-like shape. A predetermined ratio of occupied area can be set for pixel points on the circumference. When a ratio of the area inside the circle that is occupied by the circumference pixel points to the total area of the pixel points is larger than the predetermined ratio of occupied area, the pixel points are considered as pixel points of the point light source for the circle-like shape. The size of the circle determines light intensity of the point light source and whether the photoelectric sensor is able to obtain images with better quality. If the circle is too small, the point light source region would be too small, thereby producing insufficient light; if the circle is too big, the point light source region would be too big, thereby affecting imaging quality. Similarly, different display panels may have different light source intensities, so the size of the point light source region also varies from display panel to display panel. For a particular image-imaging-acquiring structure, the size of the point light source region can also be obtained by adopting multiple manual testing. The size of the point light source region can be lit up in a small-to-large order. Then, after the photoelectric sensor has obtained image data, a smallest point light source region with a satisfying imaging quality is manually selected.

The interval between the point light sources depends on imaging quality, and this interval is determined by an interval between the light source and the upper surface of the light-permeable cover plate, and these two intervals are directly proportional. In order to prevent overlap between images, the interval between two adjacent point light sources satisfies a condition that point light source total reflection images that are collected by the photoelectric sensor do not contact and do not repeat. Using a system with an active-matrix organic light-emitting diode (AMOLED) display screen of a Samsung Galaxy Round smartphone, a Taiwan Innolux thin film transistor (TFT) X-ray sensor, and a light-permeable cover plate with a thickness of approximately 0.7 mm as an example, it is determined that the array structural parameter of the point light source array is that the interval between two point light sources is the width of 80 pixels (with the display used in the system, an actual interval is approximately 5.26 mm), as shown in FIG. 7.

The present invention also provides a storage medium, the storage medium storing a computer program that, when executed by a processor, implements the steps of the above method. The storage medium in this embodiment may be a storage medium disposed in an electronic device, and the electronic device may access the content of the storage medium and achieve the effect of the present invention. The storage medium may also be a separate storage medium, and when the storage medium is connected to an electronic device, the electronic device can access the content in the storage medium and implement the method steps of the present invention. In this manner, the method of the embodiment of the present invention can run on an image acquisition structure, and the driving of the light source and the acquisition of the image under the screen are implemented.

The invention provides an electronic device that includes a storage, a processor, and an image acquiring structure. The image acquiring structure includes a light-permeable cover plate, a display panel and a photoelectric sensor. The display panel and the photoelectric sensor are disposed below the light-permeable cover plate, and the processor and the display panel are connected to the photoelectric sensor, a computer program is stored in the storage, and when the computer program is executed by a processor, the steps of the method according to any one of the foregoing are implemented. The electronic device of this embodiment forms a point light source by using multiple pixel points, which increases the brightness of the point light source and improves the quality of lens-free under-screen optical image imaging. At the same time, multiple point light sources are used for image imaging, which also improves imaging efficiency.

It needs to be made clear that although description with respect to each above-mentioned embodiment has been given in this specification, the patent protection scope of the present invention is not limited thereby. Therefore, based on the novel idea of the present invention, any alteration or modification made to the embodiments described in this specification, or equivalent structure or equivalent flow change that is made by using the content of the specification and the accompanying figures of the present invention, directly or indirectly applying the above-mentioned technical schemes in other related technical fields, are each included in the patent protection scope of the present invention.

1. A driving method used for under-screen imaging, characterized by comprising steps of:
lighting up pixel points of a plurality of separate point light source areas of a display panel, the point light source areas being arranged in an array and spaced with nonluminous pixel points;
obtaining, through photoelectric sensor, light of the pixel points that is totally reflected by light-permeable cover plate; the display panel and the photoelectric sensor being placed under the light-permeable cover plate.

2. The driving method used for under-screen imaging of claim 1, characterized in that: the array arrangement is lateral-arrangement-and-longitudinal-arrangement, or the array arrangement is ring arrangement.

3. The driving method used for under-screen imaging of claim 1, characterized in that: an interval between two adjacent point light sources satisfies a condition that point light source total reflection images that are collected by the photoelectric sensor do not contact and do not repeat.

4. The driving method used for under-screen imaging of claim 1, characterized in that: a wavelength of the point light sources is 515 nm to 700 nm.

5. The driving method used for under-screen imaging of claim 1, characterized in that, prior to lighting up the pixel points, the driving method further comprises:
performing value-assignment for a matrix that has a same resolution as that of the display panel, assigning non-zero values to the point light source areas, assigning a zero value to other regions, and generating a display image using the matrix that has assigned values as RGB information;
transmitting the display image to the display panel.

6. The driving method used for under-screen imaging of claim 1, characterized in that: the point light source areas include a plurality of pixel points.

7. The driving method used for under-screen imaging of claim 1, characterized in that: the point light source area is a circle-like shape, a rectangle, a rhombus, or a triangle.

8. The driving method used for under-screen imaging of claim 1, characterized in that: the display panel is a liquid-crystal display, an active-matrix organic light-emitting diode display or a micro light-emitting diode display.

9. The driving method used for under-screen imaging of claim 1, characterized in that it further comprises steps of:
after a preset time interval, performing a same position shifting on all of the point light source areas;
repeating the step of lighting up pixel points and the step of obtaining light.

10. The driving method used for under-screen imaging of claim 9, characterized in that the repeating of the step of lighting up pixel points and the step of obtaining light includes:
repeating the step of lighting up pixel points and the step of obtaining light for a preset number of times.

11. The driving method used for under-screen imaging of claim 10, characterized in that: the preset number of times is six or more.

12. The driving method used for under-screen imaging of claim 9, characterized in that:
the position shifting includes shifting the point light source in a direction toward an adjacent point light source;
an interval of the position shifting is the interval between the adjacent point light sources divided by an integer.

13. The driving method used for under-screen imaging of claim 9, characterized in that:
the array arrangement is lateral-arrangement-and-longitudinal-arrangement that are perpendicular to each other;
the position shifting includes a lateral shifting, a longitudinal shifting, or a shifting in a direction of ±45 degrees.

14. The driving method used for under-screen imaging of claim 13, characterized in that:
an interval of the lateral shifting is a lateral interval between the adjacent point light sources divided by an integer;
an interval of the longitudinal shifting is a longitudinal interval between the adjacent point light sources divided by an integer;
an interval of the shifting in the direction of ±45 degrees is an interval between the adjacent point light sources in the direction divided by an integer.

15. An image acquiring method used for under-screen imaging, characterized by comprising steps of:
acquiring light data using a driving method of claim 9; and
performing stitching process on the light data obtained by the photoelectric sensor in multiple instances of the step of lighting up pixel points and multiple instances of the step of obtaining light, so as to obtain stitched image data.

16. A storage medium, characterized in that: the storage medium stores a computer program which, when executed by a processor, implements the steps of the method of claim 1.

17. An electronic device, characterized by: comprising a storage, a processor and an image obtaining structure, said image obtaining structure including a light-permeable cover plate, a display panel and a photoelectric sensor, said display panel and said photoelectric sensor being placed under said light-permeable cover plate, said processor being coupled to said display panel and said photoelectric sensor, said storage storing a computer program therein, the computer program, when executed by the processor, implementing the steps of the method of claim 1.

18. The driving method used for under-screen imaging of claim 6, characterized in that: the point light source area is a circle-like shape, a rectangle, a rhombus, or a triangle.

19. An image acquiring method used for under-screen imaging, characterized by comprising steps of:
acquiring light data using a driving method of claim 10; and
performing stitching process on the light data obtained by the photoelectric sensor in multiple instances of the step of lighting up pixel points and multiple instances of the step of obtaining light, so as to obtain stitched image data.

20. An image acquiring method used for under-screen imaging, characterized by comprising steps of:
acquiring light data using a driving method of claim 11; and
performing stitching process on the light data obtained by the photoelectric sensor in multiple instances of the step of lighting up pixel points and multiple instances of the step of obtaining light, so as to obtain stitched image data.
